(19) United States
(12) Patent Application Publication
(10) Pub. No.: US 2009/0058176 A1
(43) Pub. Date: Mar. 5, 2009

(54) Blow moulded wheel

(76) Inventors: Patrick Beirne, Co. Westmeath (IE); Thomas Mullen, Co. Meath (IE)

Correspondence Address: JACOBSON HOLMAN PLLC, 400 SEVENTH STREET N.W., SUITE 600, WASHINGTON, DC, 20004, US

(21) Appl. No.: 12/230,376

(22) Filed: Aug. 28, 2008

Related U.S. Application Data
(60) Provisional application No. 60/935,768, filed on Aug. 30, 2007.

(51) Int. Cl. B60B 5/02

(52) U.S. Cl. 301/36.1; 301/64.701; 280/79.2

(57) ABSTRACT

A single piece blow-moulded plastics wheel 1 for a trash cart 6 comprises an inner hub part 2, an outer rolling part 3, and spoke parts 4. The hub part 2 has a bore 5 extending therethrough. A spacer section 8 projects outwardly from one side of the hub part 2 and a recess 15 on the opposite side. The spacer section 8 of one wheel is engageable in the recess 15 of another similar wheel for stacking the wheels during transportation and storage.

### INTRODUCTION

This invention relates to a wheel. More particularly, the invention relates to a blow-moulded wheel suitable for use with a garbage cart or a wheelie bin.

### STATEMENTS OF INVENTION

According to the invention there is provided a wheel comprising a plastics body having an outer rim and a hub which defines a central inner bore extending from one side of the wheel, the hub having an integral spacer extending from one side of the wheel and a recess on the opposite side of the wheel.

In one embodiment the spacer part is of complementary size and shape to the size and shape of the recess part so that the spacer part is receivable in the recess of another like wheel, on stacking.

Preferably the spacer comprises an axially extending portion and a radially extending portion, the wall of the axially extending portion being contiguous.

In one embodiment the wheel comprises a spoke part extending between the outer rim and the hub, and a flange part between the hub and the spoke part. Preferably the flange part has a larger wall thickness than that of the spoke part. In one case the wheel has a first flange part on the spacer side of the wheel and a second flange part on the recess side of the wheel.

In a preferred embodiment the wheel is a blow moulded plastics wheel.

In another aspect the invention provides a wheel comprising a plastics body having an outer rim and a hub which defines a central inner bore extending from one side of the wheel to an opposite side of the wheel, the hub having an integral spacer extending from one side of the wheel, the spacer comprising an axially extending portion and a radially extending portion, the wall of the axially extending portion being contiguous.

The invention further provides a stack of wheels comprising at least a first wheel and a second wheel, the first wheel comprising a plastics body having an outer rim and a hub which defines a central inner bore extending from one side of the wheel to an opposite side of the wheel, the hub having an integral spacer extending from one side of the wheel and a recess on the opposite side of the wheel;

the second wheel comprising a plastics body having an outer rim and a hub which defines a central inner bore extending from one side of the wheel to an opposite side of the wheel, the hub having an integral, spacer extending from one side of the wheel and a recess on the opposite side of the wheel;

the spacer of the first wheel being engaged in the recess of the second wheel.

The invention also provides an assembly comprising an axle and a pair of wheels of the invention mounted on the ends of the axle.

The invention further provides a garbage cart comprising a garbage receptacle having a wheeled axle assembly of the invention.

### BRIEF DESCRIPTION OF THE DRAWINGS

The invention will be more clearly understood from the following description of some embodiments thereof, given by way of example only, with reference to the accompanying drawings, in which:

FIG. 1 is an isometric, partially cross sectional view of a wheel according to the invention;

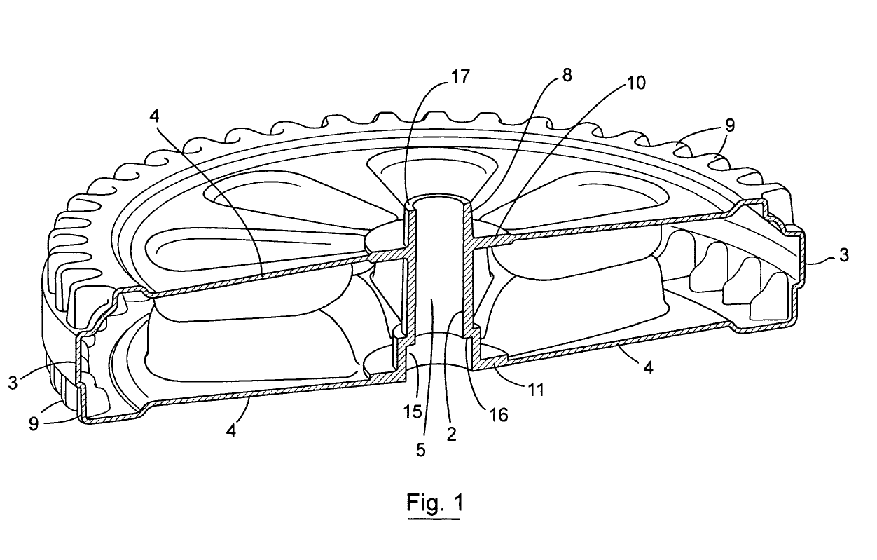

FIG. 2 is a cross sectional view of a stack of wheels of FIG. 1;

FIG. 3 is a cross sectional view of the wheel in use; and

FIG. 4 is an isometric view of the wheel, in use.

### DETAILED DESCRIPTION

Referring to the drawings there is illustrated a single piece blow-moulded wheel 1 according to the invention.

The wheel 1 comprises an inner hub part 2, an outer rolling part 3, and spoke parts 4 extending between the hub part 2 and the rolling part 3. The hub part 2, the rolling part 3 and the spoke parts 4 are formed integrally by blow moulding of a plastics material such as high density polyethylene (HDPE).

The hub part 2 comprises a bore 5 extending therethrough. The wheel 1 may be mounted to a trash cart 6 by extending an axle 7 of the trash cart 6 through the bore 5.

The rolling part 3 comprises a tread surface 9 extending around the circumference of the rolling part 3 to provide the wheel 1 with improved grip.

The wheel 1 further comprises a spacer section 8 projecting outwardly from the inner side of the hub part 2. The spacer section 8 is provided in the form of a single contiguous walled tube formed integrally with the hub part 2 as an extension of the hub wall which defines the bore 5.

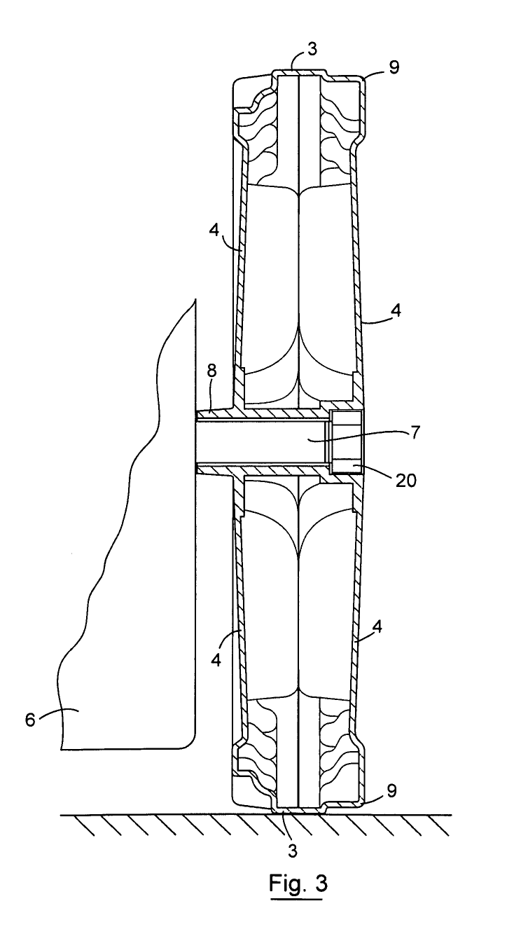

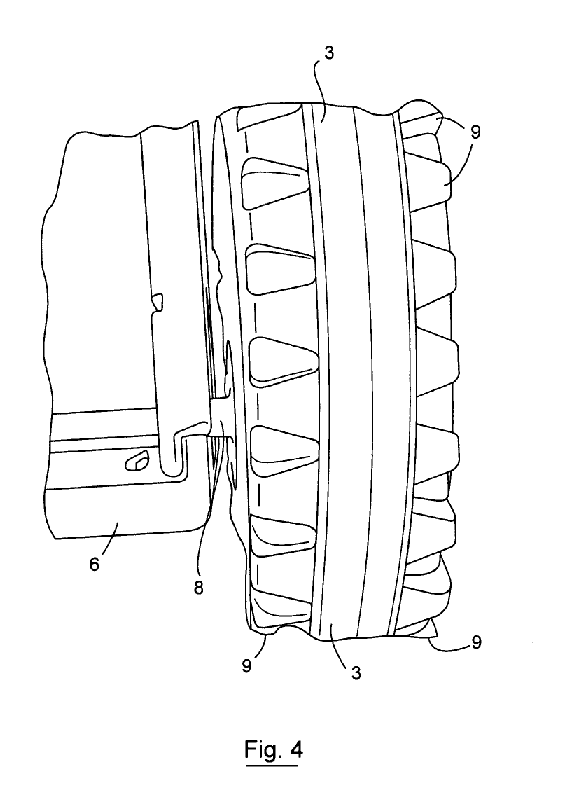

In use, the spacer section 8 is engageable with part of the trash cart 6 to maintain the rolling part 3 of the wheel 1 spaced-apart from the trash cart 6 (FIGS. 3 and 4).

The hub part 2 has integrally formed inner and outer flanges 10, 11 which form transitions between the hub part 2 and the spoke part 4. The flanges 10, 11 are of thicker wall section than that of the hub part 4 to reinforce the junction region between the spoke part 4 and the hub part 2. The spacer section 8 projects outwardly from the flange 10 and the flange 10 thereby reinforces the spacer section 8 for enhanced load bearing. The projection also facilitates stacking as will be described in more detail below. Because the spacer section 8 comprises a contiguous single cylindrical wall it provides enhanced strength in use.

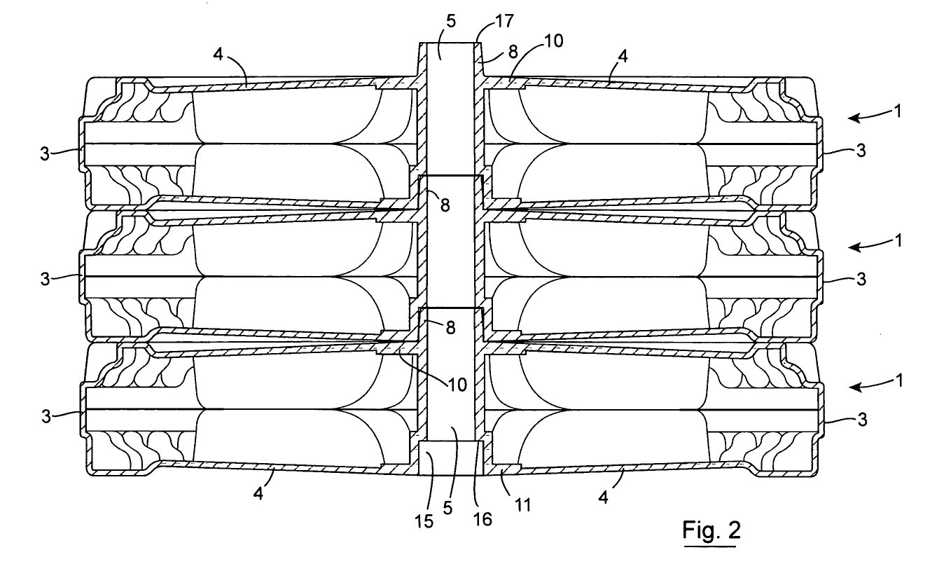

The hub part 2 also has a recess 15 at the side of the wheel opposite to the spacer section 8. The recess 15 is defined by an enlarged portion of the bore 5. A step 16 in the bore wall provides a stop against which a spacer end face 17 engages an insertion of the spacer section 8 of one wheel 1 in a recess 16 of another like wheel 1 on stacking of the wheels as illustrated in FIG. 2. The recess 15 also accommodates on mounting element 20 for the axle 7.

Thus, the wheels are stackable for storage and transportation which not only reduces the space required to house the wheels in storage and transport but also stabilises the wheels during transport thereby reducing risk of damage in handling.

The invention is not limited to the embodiments hereinbefore described, with reference to the accompanying drawings, which may be varied in construction and detail.

1. A wheel comprising a plastics body having an outer rim and a hub which defines a central inner bore extending from one side of the wheel, the hub having an integral spacer extending from one side of the wheel and a recess on the opposite side of the wheel.

2. A wheel as claimed in claim 1 wherein the spacer part is of complementary size and shape to the size and shape of the recess part so that the spacer part is receivable in the recess of another like wheel, on stacking.

3. A wheel as claimed in claim 1 wherein the spacer comprises an axially extending portion and a radially extending portion, the wall of the axially extending portion being contiguous.

4. A wheel as claimed in claim 1 comprising a spoke part extending between the outer rim and the hub, and a flange port between the hub and the spoke part.

5. A wheel as claimed in claim 4 wherein the flange part has a larger wall thickness than that of the spoke part.

6. A wheel as claimed in claim 4 wherein the wheel has a first flange part on the spacer side of the wheel and a second flange part on the recess side of the wheel.

7. A wheel as claimed in claim 1 wherein the wheel is a blow moulded plastics wheel.

8. A wheel comprising a plastics body having an outer rim and a hub which defines a central inner bore extending from one side of the wheel to an opposite side of the wheel, the hub having an integral spacer extending from one side of the wheel, the spacer comprising an axially extending portion and a radially extending portion, the wall of the axially extending portion being contiguous.

9. A wheel as claimed in claim 8 comprising a spoke part extending between the outer rim and the hub, and a flange part between the hub and the spoke part.

10. A wheel as claimed in claim 8 wherein the flange part has a larger wall thickness than that of the spoke part.

11. A wheel as claimed in claim 8 wherein the wheel is a blow moulded plastics wheel.

12. A stack of wheels comprising a first wheel and at least a second wheel,
the first wheel comprising a plastics body having an outer rim and a hub which defines a central inner bore extending from one side of the wheel to an opposite side of the wheel, the hub having an integral spacer extending from one side of the wheel and a recess on the opposite side of the wheel;
the second wheel comprising a plastics body having an outer rim and a hub which defines a central inner bore extending from one side of the wheel to an opposite side of the wheel, the hub having an integral spacer extending from one side of the wheel and a recess on the opposite side of the wheel;
the spacer of the first wheel being engaged in the recess of the second wheel.

13. An assembly comprising an axle and a pair of wheels as claimed in claim 1 mounted on the ends of the axle.

14. An assembly comprising an axle and a pair of wheels as claimed in claim 8 mounted on the ends of the axle.

15. A garbage cart comprising a garbage receptacle having a wheeled axle assembly as claimed in claim 13.

16. A garbage cart comprising a garbage receptacle having a wheeled axle assembly as claimed in claim 14.
